(19) United States
(12) Patent Application Publication
(10) Pub. No.: US 2008/0286854 A1
(43) Pub. Date: Nov. 20, 2008

(54) Method for Enriching Lignocellulose Residues With Yeast Protein

(75) Inventors: Fidel Domenech, Ciuda Habana (CU); Sergio Revah-Moissev, Col. Lomas Virreyes (MX); Pierre Christen, Marseille (FR)

Correspondence Address: Young & Thompson, 745 S. 23rd Street., Second Floor, Arlington, VA, 22202, US

(73) Assignee: UNIVERSIDAD AUTONOMA METROPOLITANA (U.A.M.I.), Col Vicentina, D.F. Apdo. (MX)

(21) Appl. No.: 11/916,852

(22) PCT Filed: Jun. 6, 2006
(86) PCT No.: PCT/FR06/01283

§ 371 Date: Apr. 1, 2008

(30) Foreign Application Priority Data
Jun. 7, 2005 (FR) 05/05762

(51) Int. Cl. A62D 3/02

(52) U.S. Cl. 435/262.5

(57) ABSTRACT

The invention relates to the use of sugar cane molasses and distillery slop for carrying out a method for enriching lignocellulose residue, especially bagasse or straw, with yeast protein. The invention also relates to said lignocellulose residue enrichment method, and to the product thus obtained.

A subject of the present invention is a process for enriching a lignocellulosic residue, for example sugar cane bagasse, with yeast proteins, comprising in particular the use of sugar cane molasses and distillery slops. Another subject is the enriched bagasse as obtained.

Some of the discharges from sugar refineries and alcohol distilleries are harmful to the environment. In fact, the sugar industry actually produces two tonnes of sugar cane bagasse, which is a fibrous lignocellulosic solid residue originating from crushing the plant, per tonne of refined sugar, which represents, in Cuba, 10 to 20 millions of tonnes of bagasse per year. Another pollutant by-product is sugar cane molasses which is a liquid residue very rich in sugars and certain mineral salts. Moreover, alcohol distilleries, which are often associated with the production of cane sugar, emit large quantities of volatile compounds more or less harmful to the environment (principally ethanol). Alcohol distilleries also discharge into the environment slops which are very polluting, but rich in mineral salts. Therefore, always in Cuba, it is estimated that 1,600 tonnes of ethanol, the emission of this compound being regulated, are discharged each year into the atmosphere.

Recently, in response to increasingly stricter legislation, numerous research programmes have been carried out in order to develop, for the cleaning up of gaseous effluents, biological processes which are simple, inexpensive, and are particularly well adapted to the treatment of large quantities of slightly contaminated air (biofiltration, for example).

Previous processes for the biofiltration of ethanol from sugar cane bagasse involve the use of a costly mineral medium (33% of the total cost of the process), the mineral medium of Thomas and Dawson (see composition in the article by Christen P, Domenech F, Michelena G, Auria R, Revah S (2002) Biofiltration of volatile ethanol using sugar cane bagasse inoculated with Candida utilis. Journal of Hazardous Materials, 89(2/3):253-265).

A purpose of the present invention is to provide a process which allows, on the one hand, the upgrading of sugar cane bagasse and, on the other, the limiting of the important emissions of ethanol into the atmosphere.

A purpose of the present invention is to provide such a process corresponding to an effective, inexpensive method of biological treatment which has industrial-scale applications, in particular in tropical countries that produce cane sugar and/or alcohol.

A purpose of the present invention is to provide a process where the yeast grows directly on a lignocellulosic support (bagasse for example) to produce a cattle feed. It therefore does not need to be cultured first in a liquid medium, then separated from this medium (centrifugation or filtration), before being mixed with the bagasse.

The present invention relates to the use of sugar cane molasses and distillery slop for the implementation of a process for enriching lignocellulosic residues, in particular bagasse or straw, with yeast proteins.

By “sugar cane molasses” is meant a liquid residue very rich in sugars and certain mineral salts (Biart, Serrano and Conde, 1982, Ed. ICIDCA, Havana, Cuba, “Estudio de las mieles de la caña de azúcar”).

Within the framework of the present invention, sugar cane molasses is used as a culture medium for preparing active inoculum from a strain of forage yeast.

The distillery slop is as described in the article by Obaya, Valdes and Ramos (1994, Acta Biotechnol, 14(2), 193-198) or in the reference “Manual de los derivados de la Caña de Azucar”, 3rd edition, City Habana, ICIDCA, 2000, chapter 6.1, Editor: Luis Galvez Taupier.

The distillery slop is an acid pollutant effluent, rich in mineral salts and commonly discharged into watercourses. Within the framework of the present invention, the slop is used as a source of mineral salts.

The lignocellulosic residue is a solid residue, originating from the crushing of plants. Straw can be cited as an example of lignocellulosic residue, the term designating generally a stem cut from certain plants, hay, sawdust, or chips from sugar beet.

The bagasse is as described in the reference: “Manual de los derivados de la Caña de Azucar”, 3rd edition, City Habana, ICIDCA, 2000, chapter 2.2, Editor: Luis Galvez Taupier.

Within the framework of the present invention, the bagasse, which is a by-product of the sugar industry, is used as a solid support for the process.

The enrichment process allows bagasse to be obtained that is enriched with yeast proteins and contains in particular at least approximately 8% of proteins relative to the total dry weight of the bagasse.

According to an advantageous embodiment, the use according to the invention is characterized in that the process for enriching bagasse with yeast proteins comprises a stage of preparation of an active inoculum by incubation of at least one strain of forage yeast, in particular Candida utilis with sugar cane molasses.

By “strain of forage yeast” is meant a yeast rich in proteins with a high nutritional value, as described in the reference “Manual de los derivados de la Caña de Azucar”, 3rd edition, City Habana, ICIDCA, 2000, chapter 4.8, Editor: Luis Galvez Taupier. Among “forage” micro-organisms, filamentous (or microscopic) fungi of Aspergillus type, or the yeast Saccharomyces cerevisiae (baking yeast) can be cited.

The present invention also relates to the use as defined above, characterized in that the process for enriching bagasse with yeast proteins comprises a stage of culturing the active inoculum as defined above, with distillery slop on sugar cane bagasse.

The present invention also relates to a process for enriching lignocellulosic residue, in particular bagasse, with yeast proteins, comprising the following stages:
the preparation of an active inoculum by incubation of at least one strain of forage yeast, in particular Candida utilis, with sugar cane molasses and
the continuous addition to the lignocellulosic residue, in particular to the sugar cane bagasse, which has been introduced to said active inoculum with distillery slop, of ethanol, in particular gaseous, or ethanol vapours, as a source of carbon, permitting the consumption of the ethanol by the aforementioned yeast and the production of lignocellulosic residue, in particular bagasse, enriched with yeast proteins.

According to a preferred embodiment, the present invention comprises the use of a strain of Candida utilis, also called Torula utilis (“Manual de los derivados de la Caña de Azucar”, 3rd edition, City Habana, ICIDCA, 2000, chapter 4.9, Editor: Luis Galvez Taupier).

According to the process of the invention, the active inoculum forms, with the distillery slop, a liquid mixture which is then mixed with the bagasse which acts as solid support.

The process of the invention is an aerobic process (which requires the presence of oxygen).

The present invention also relates to a process for enriching bagasse with yeast proteins, comprising the following stages:
the preparation of an active inoculum by incubation of at least one strain of forage yeast, in particular Candida utilis, with sugar cane molasses and
the culturing of the said active inoculum with distillery slop on sugar cane bagasse and
the continuous addition to the sugar cane bagasse of ethanol as a source of carbon, permitting the consumption of the ethanol by the aforementioned yeast and the production of bagasse enriched with yeast proteins.

Preferably, the ethanol added continuously is in gas phase. Thus, the process of the invention permits the elimination of the ethanol from an atmosphere polluted by the latter.

The originality of the process of the invention rests on the use of sugar cane bagasse, which is a by-product of the sugar industry, distillery slop which is a polluting effluent, generally discharged into watercourses, which is rich in mineral salts and ethanol vapours originating from evaporation losses during alcoholic fermentation, in order to obtain a cattle feed enriched with proteins.

Bagasse is sometimes used as cattle feed, provided that it is supplemented with proteins which can be of plant (soya) or microbial (yeasts) origin. Thus, the process of the invention allows a bagasse to be produced that is enriched with proteins starting from an active inoculum. Indeed, the commonest practice in the prior art is to produce the yeast in liquid medium, separate the medium by centrifugation and then mix it with the bagasse.

To seed the bagasse, advantageously at least 5×10⁶ yeasts per gram of dry bagasse are necessary, in particular to shorten the latency period and have a rapid growth and avoid a possible microbial contamination.

As a guideline, the rate of multiplication of the active inoculum on the bagasse under the conditions described previously is approximately 100 in approximately 7 days.

According to an advantageous embodiment, the process for enriching bagasse with yeast proteins of the present invention comprises the following stages:
the preparation of an active inoculum by incubation of at least one strain of forage yeast, in particular Candida utilis, with sugar cane molasses,
the mixing of the active inoculum as obtained in the previous stage with distillery slop,
the introduction of the mixture as obtained in the previous stage on sugar cane bagasse and
the continuous addition to the sugar cane bagasse of ethanol as a source of carbon, permitting the consumption of the ethanol by the aforementioned yeast and the production of bagasse enriched with yeast proteins.

This stage of mixing the liquids (slop and active inoculum) in the presence of a solid (bagasse) allows the liquids and the bagasse to be more easily homogenized.

According to an advantageous embodiment, the process for enriching bagasse with yeast proteins of the invention comprises the following stages:
the preparation of an active inoculum by incubation of at least one strain of forage yeast, in particular Candida utilis, with sugar cane molasses,
the filling of a reactor with sugar cane bagasse, active inoculum as obtained in the previous stage and distillery slop and
the continuous feeding of the said reactor filled according to the previous stage with ethanol vapours, permitting the consumption of the said ethanol vapours by the aforementioned yeast and the production of bagasse enriched with yeast proteins.

According to a particular embodiment, the bagasse is placed in bags of synthetic fibre, able to contain between 3 and 17 kilograms of wet bagasse (corresponding to the initial medium) having a mesh size sufficient to allow the gases to pass and diffuse and yet narrow enough to contain the bagasse and prevent it from dispersing. This makes it easier to handle the wet bagasse when placing it in the reactor and also to facilitate the handling of the finished product that can be used immediately for cattle.

The present invention also relates to a process for enriching bagasse with yeast proteins, as defined above, comprising the following stages:
the preparation of an active inoculum by incubation of at least one strain of forage yeast, in particular Candida utilis, with sugar cane molasses,
the filling of a reactor with sugar cane bagasse and active inoculum as obtained in the previous stage, cultured with distillery slop, and
the continuous feeding of the said reactor filled according to the previous stage with ethanol vapours, permitting the consumption of the said ethanol vapours by the aforementioned yeast and the production of bagasse enriched with yeast proteins.

The present invention also relates to a process for enriching bagasse with yeast proteins as defined above, comprising the following stages:
the preparation of an active inoculum by incubation of at least one strain of forage yeast, in particular Candida utilis, with sugar cane molasses,
the mixing of the active inoculum as obtained in the previous stage with distillery slop,
the filling of a reactor with the mixture as obtained in the previous stage and sugar cane bagasse, and
the continuous feeding of the said reactor filled according to the previous stage with ethanol vapours, permitting the consumption of the said ethanol vapours by the aforementioned yeast and the production of bagasse enriched with yeast proteins.

In the process of the invention, it is not necessary to regulate the pH of the medium. On the contrary, the observed acidification (up to a pH of 2.5) allows bacterial contamination to be limited.

Nor is it necessary to regulate the temperature. Some of the excess metabolic heat is actually eliminated thanks to the recirculation of the liquid medium, the primary purpose of which is to prevent the medium from drying. Another part of the metabolic heat is eliminated with the gas stream feeding the reactor.

According to an advantageous embodiment, in the process of the invention, the sugar cane bagasse is ground fresh bagasse, the particles of which have a diameter of approximately 0.1 to approximately 5 mm, and preferably of approximately 0.54 mm to approximately 3 mm.

The particles used are small in order to have the greatest possible specific volume area available. However, if working with even smaller particles, the powder (bagasse) will be very compact, which risks causing problems of diffusion of the gases (oxygen and ethanol) and of the slop, through the support.

An advantageous process according to the present invention is characterized in that the sugar cane molasses used in the stage of preparation of the inoculum is supplemented by nitrogen, and in particular by ammonium sulphate and ammonium phosphate.

The use of these two nitrogen salts allows the quantity of yeast produced to be increased. In fact, when supplements are not used, the molasses is not enough rich and the growth of the yeast is lower.

According to the present invention, the inoculum is produced from sugar cane molasses, which is a by-product of sugar extraction. But, in the earlier processes already known, the culture medium used is, for example, a solution of glucose and a yeast extract, which are more expensive ingredients.

The present invention also relates to a process as defined above, characterized in that the strain of yeast is incubated in the presence of approximately 22 to approximately 82 g·L⁻¹, in particular approximately 42 to approximately 62 g·L⁻¹, and preferably approximately 52 g·L⁻¹, of molasses, of approximately 3 to approximately 8 g·L⁻¹, in particular of approximately 4 to approximately 7 g·L⁻¹, and preferably approximately 5.5 g·L⁻¹, of ammonium sulphate, and of approximately 0.5 to approximately 2 g·L⁻¹, and preferably approximately 1.2 g·L⁻¹, of ammonium phosphate.

According to an advantageous embodiment, the composition of the medium for the inoculum is as follows (for a litre): 52 g of molasses (dilution 1:17); 5.45 g of ammonium sulphate and 1.22 g of ammonium phosphate. This adaptation of the preparation medium of the inoculum allows any equally active inoculum to be produced, i.e. that the latency phase is short and, consequently, the growth of the yeast starts very quickly on the bagasse, and slightly denser (at least 1.75×10⁸ cells/ml) than when using glucose and yeast extract for the preparation of this medium.

According to an advantageous embodiment, the process of the invention is characterized in that the stage of incubation of the strain of yeast with the sugar cane molasses is carried out at a temperature of approximately 25 to approximately 35° C., and preferably equal to approximately 30° C., for a period varying from approximately 15 hours to approximately 22 hours, and preferably for a period of approximately 18 hours.

The present invention also relates to a process as defined above, characterized in that the distillery slop is enriched beforehand with nitrogen salts and magnesium salts, said slop preferably being enriched beforehand with ammonium sulphate at the rate of approximately 73 g·L⁻¹, with ammonium phosphate at the rate of approximately 22 g·L⁻¹ and with magnesium sulphate at the rate of approximately 7 g·L⁻¹.

The use of the slop enriched with ammonium sulphate, with magnesium sulphate and with ammonium phosphate allows a greater growth of the yeast, which leads to an increase in the capacity to eliminate the ethanol vapours.

An advantageous process according to the present invention is characterized in that the strain of yeast has water added, in order to obtain a water content of approximately 60 to approximately 75%, and preferably of approximately 65% relative to the total weight of the wet bagasse.

This quantity of water allows the saturation of the bagasse with water, which encourages the growth of the yeast.

According to an advantageous embodiment, in the process of the present invention, the reactor is fed with the ethanol at the rate of approximately 100 g·h⁻¹·m⁻³ of reactor to approximately 200 g·h⁻¹·m⁻³ of reactor, and preferably at the rate of approximately 150 to approximately 200 g·h⁻¹·m⁻³ of reactor.

One of the special features of the process of the invention rests on the fact that it is important not to exceed an ethanol concentration of 10 g·m⁻³ in the gas stream. Preferably, the ethanol concentration is 6 to 8 g·m⁻³ of air. This range of ethanol concentration in the air feeding the reactor must limit the phenomena of inhibition of the metabolism of the yeast and the production of intermediate volatile metabolites that may be toxic (acetaldehyde).

The present invention also relates to a process as defined above, characterized in that the stage of feeding the reactor with ethanol is carried out continuously in particular for approximately 7 days at ambient temperature.

According to an advantageous embodiment, in the process according to the present invention, the reactor can be fed with ethanol in descending flow and/or in ascending flow.

The reactor is advantageously fed with ethanol in descending flow.

In fact, when the reactor is supplied in ascending flow, the following problem may be encountered: a marked condensation of the water vapour close to the outlet of the reactor (upper part), which leads to a pressure drop and encourages microbial contamination.

When the reactor is fed in descending flow, the problems of condensation in the upper part of the reactor disappear, as the water which could have collected at the base of the reactor is naturally eliminated by gravity.

It is also possible to use descending flow and ascending flow alternately, which allows the growth of the yeast to be evened out over the whole height of the reactor.

The present invention also relates to a process as defined above, characterized in that the upper part of the reactor is sprayed with a solution of slop as defined above, enriched beforehand with nitrogen salts and magnesium salts, as defined previously.

According to an advantageous embodiment, the upper part of the reactor is sprayed with the excess slop which is drained into a cone situated at the base of the reactor, by a pump which operates for 5 minutes every hour. This liquid which recirculates corresponds to the slop initially added to the bagasse. The recirculation pump is used at rate of 0.1 to 0.4 ml/minute, and preferably equal to 0.25 ml/minute.

According to an advantageous embodiment, to deal with the problems of an increase in the temperature and of the subsequent drying, in the system for humidifying the medium, the humidification column for the air feeding the reactor is replaced by a direct humidification of the medium by discontinuous spraying of the reactor from above. This has the effect of reducing the phenomena of drying (more effective humidification) and controlling the rise in temperature thanks to the energy consumed during the evaporation of this water. Moreover, it is a much more economical method than the prior humidification of the air.

Thus, the humidification by recirculation of the liquid phase, combined with the use of supplemented slop, as described above, allows a greater growth of the yeast and an increase of the ethanol elimination capacity.

The present invention also relates to a process as defined above, characterized in that of the water is added punctually during the process, in particular in a quantity comprised from 50 mL to 200 mL per litre of reactor per day, which corresponds to a quantity comprised from 1 to 2 litres for a culture medium volume of approximately 16 litres.

According to a preferred embodiment, the process of the invention is characterized in that it comprises a supplementary final stage consisting of drying with dry air the final product corresponding to the bagasse enriched with yeast proteins and collecting the thus-dried product, in order to facilitate its stability, its storage and its possible transport.

An advantageous process is a process as defined above, characterized in that the bagasse enriched with yeast proteins presents a protein content of approximately 5 to approximately 17%, and preferably of approximately 17% relative to the total weight of dried bagasse.

The present invention also relates to a product as obtained according to the process as defined above.

The process of the present invention can in particular be used in particular in the environmental field, in order to permit, on the one hand, the reduction of the pollution of watercourses where slop rich in mineral salts and at an acid pH (of the order of 4) is discharged (Delbecq D, Le sucre, une douceur amère pour l'environnement, Liberation, 22 Nov. 2004), and, on the other, in order to permit the reduction of atmospheric pollution by the ethanol vapours originating from distillation tanks (although not considered very toxic, this volatile molecule is nevertheless the subject of legislation in Europe: an individual must not be exposed for more than 8 h to a concentration of 1000 ppm in the air (Cioci F, Lavecchia R, Ferranti M M (1997) High-performance microbial removal of ethanol from contaminated air. Biotech. Techniques, 11:893-898)).

The process of the present invention can also be used in the food sector, given that the finished product constitutes a cattle feed (ruminants) that is rich in fibre and enriched with proteins. It is of particular interest in countries that have a deficit in animal feed proteins (Cuba, India) and/or produce sugar cane (Brazil, India, Cuba, Mexico, etc.).

Experimental Part

The present invention is the result of experiments which tested the capacities of several strains of the yeast Candida utilis for:
eliminating ethanol (emitted by alcohol distilleries, breweries or industrial-scale bakeries) and converting it to CO₂ and H₂O (total oxidation) by means of a biofiltration process,
and/or using this ethanol to produce biomass (unicellular proteins) for animal feed.

The experiments conducted within the framework of the present invention were carried out on a pilot scale. More precisely, they were carried out using a 20-litre pilot plant reactor.

During the first tests, the average observed CE (elimination capacity) for ethanol is 120 g/h·m³ of ethanol (period of 12 days) and on the 16th day the biomass produced is of the order of 129 g/kg of bagasse. The CE of the ethanol vapours is calculated according to the following equation:

$$CE = \frac{( {C}_{e} - {C}_{s} ) * F}{V} \qquad ( 1 )$$

with CE: elimination capacity (g/h·m³)
Ce and Cs: concentration of ethanol on entering and on leaving the reactor (g/m³)
F: aeration (M³/h)
V: volume of the reactor (m³)

According to a preferred embodiment, the direction of the air+ethanol feed was reversed (descending flow). The problems of condensation in the top part of the reactor disappeared, and at the base of the reactor the liquid phase (water and/or slop) which could have collected is eliminated naturally by gravity.

According to another preferred embodiment, the humidification column for the air feeding the reactor is replaced by a direct humidification of the medium by discontinuous spraying of the reactor from above. This has the effect of reducing the phenomena of drying (more efficient humidification) and controlling the increase of the temperature thanks to the energy consumed during the evaporation of this water. Moreover, this method of humidification of the medium is much more economical than the humidification of air, which requires a column of a volume equivalent to that of the reactor.

Moreover, given the cost of the mineral medium of Thomas and Dawson (Christen P, Domenech F, Michelena G, Auria R, Revah S (2002) Biofiltration of volatile ethanol using sugar cane bagasse inoculated with Candida utilis. Journal of Hazardous Materials, 89(2/3):253-265), this mineral medium was replaced by distillery slop produced during alcoholic fermentation using sugar cane molasses as substrate. Slop is an acid effluent rich in mineral salts that is commonly discharged into watercourses, polluting them. It is used at a rate of 1.04 L per kg of bagasse and duly supplemented with cheap sources of nitrogen (ammonium sulphate, 73 g/l and ammonium phosphate, 22 g/l) and magnesium (magnesium sulphate, 7 g/l).

These two modifications (humidification by recirculation of the liquid phase and use of the supplementary slop) allowed a greater growth of the yeast in the inlet module (356 g/kg of bagasse), as well as an increase of the EC of the ethanol (elimination of 99.8% of a load of 186 g/h·m³).

According to a preferred embodiment, a larger aeration flow was used without modifying the load (which means reducing the inlet concentration of ethanol to values of the order of 8 g/m³). This relatively smaller ethanol concentration in the air feeding the reactor must limit the phenomena of inhibition of the metabolism of the yeast and the production of intermediate volatile metabolites that may be toxic (acetaldehyde). This embodiment thus allows a broad longitudinal heterogeneity of the concentration of biomass in the reactor to be avoided, with a much greater growth of the yeast in the inlet module of the ethanol (356 g/kg of bagasse) that in the outlet module (76 g/kg of bagasse), which results in a partial operation of the reactor in terms of EC, with more of 85% of the ethanol eliminated in the inlet module and only 2% in the outlet module (observed during the third test of this pilot-plant reactor).

The increase in the air flow allowed a better distribution of the consumption of the ethanol (57.5% in the inlet module, and 8.9% at the outlet) and of the biomass produced (208 and 81 g/kg of bagasse in the inlet and outlet modules respectively). The average EC of the system is 161 g/h·m³.

According to another preferred embodiment, the reactor is fed alternately with air+ethanol: one day in two from above and one day in two from below. Thus, this embodiment allows the homogeneity of the growth in the reactor to be further improved.

Given the large volumes of inoculum needed to seed the medium (0.57 l/kg of dry matter), it was decided to produce the inoculum from sugar cane molasses, a by-product of sugar extraction, instead of the much more expensive solution of glucose and yeast extract used on a laboratory scale. The composition of the medium for the inoculum is as follows (per litre): molasses, 52 g (dilution 1:17); ammonium sulphate, 5.45 g; ammonium phosphate, 1.22 g. This change allowed an inoculum to be produced that was just as active and denser than the previous one (1.75×10⁸ cells/ml as against 1.53×18 cells/ml), over an identical period (22 h) and at less cost.

### EXAMPLE

### Essential Stages of the Process

1. preparation of the bagasse: preferably fresh bagasse is taken and ground in order to obtain particles smaller than 20 mm;

2. production of the inoculum in liquid medium from the molasses duly supplemented with ammonium sulphate and ammonium phosphate (incubation between 15 and 20 h), in order to obtain active inoculum at the end of 14 hours (approximately 14 to 18 hours);

3. preparation of the “solid” culture medium on the bagasse, mixing the active inoculum, the slop previously enriched with nitrogen and magnesium salts and the quantity of water necessary to obtain a water content of 65%;

4. filling of the reactor and feeding ethanol vapours by ascending or descending flow; and

5. periodic recirculation of the liquid phase (5 min each hour).

Starting Products

With the exception of the yeast, they can all be considered to various degrees to be examples of pollutant by-products of the agri-foodstuffs industry: distilleries (slops and ethanol vapours), sugar refineries (cane bagasse).

Sugar cane molasses can be used as culture medium for the production of the starting inoculum.

The yeast employed can be Candida utilis.

End-Product

Cane bagasse enriched with yeast proteins for cattle feed (minimum content: 8% proteins)

Proportions of each Constituent

On the basis of a kg of bagasse (dry), the following are used:

| | |
|---|---|
| Slop | 1.04 l |
| Ammonium sulphate | 76 g |
| Ammonium phosphate | 23 g |
| Magnesium sulphate | 7.3 g |
| Ethanol vapours | the load must |
| | not exceed |
| | 200 g/h.m³ |
| Molasses (for the preparation of the inoculum) | 32.4 g |

### DETAILED DESCRIPTION

A 20-litre bio-reactor, comprising 3 plexiglass modules, was assembled (Aizpuru A., Dunat D., Christen P., Auria R., Garcia-Peña I., Revah S. (2005) Fungal biofiltration of toluene on ceramic rings. Journal of Environmental Engineering, 131: 396-402).

Effective volume of the reactor: 19.83 L; comprised of 3 modules (volume of each: 6.61 L; diameter: 18 cm; height: 26 cm)

The air is fed by a pump and the flow of air is regulated by a flowmeter fitted with a needle valve. The same applies to the air which will bubble in a vessel containing the (liquid) ethanol. The adjustment of this flow allows the ethanol concentration in the air entering the reactor to be accurately fixed.

Each module is fitted with a port for taking samples of the support (bagasse) in the middle of each module in order to monitor the evolution of the pH, the humidity and the growth of the yeast. This is determined by counting the cells using a microscope and by the determination of total protein by the Barnstein method (Winton A. L. and Winton K. B., 1983, Metodos químicos generales: Proteínas. Análisis de los Alimentos. Editorial Pueblo y Educación, Havana, Cuba). Each module is also equipped with ports for sampling the air (inlet and outlet) in order to determine the concentrations of ethanol, of CO₂ and of any volatile metabolites (acetaldehyde and ethyl acetate) in the air. This allows the behaviour of the reactor to be monitored and, at the end of the experiment, a carbon balance to be produced.

Procedure.

The air+ethanol mixture is fed to the reactor continuously either in one direction (ascending or descending) or alternately. Periodically, the top of the reactor is sprayed with water and sometimes (in the case where a reduction in the ethanol elimination efficiency is observed), a solution of diluted slop supplemented with N and P can be added. The yeast consumes the ethanol and converts it to biomass—as long as no limitation of one of the nutriments appears—and to CO₂. The process requires neither the regulation of temperature nor pH.

When the growth is finished (at the end of a week approximately), dry air is passed into the reactor in order to dry the product and improve its storage life.

One of the advantages of this process is that the yeast produces acids (in particular acetic acid) which reduce the pH of the medium to values of 2.5 to 3, which greatly limits the contamination of the medium by other micro-organisms (bacteria in particular).

Results

Several experiments were carried out and the results obtained are the following:

Operating Conditions

| | |
|---|---|
| Initial water content of the bagasse | 65% |
| Rate of inoculation | 1.78 × 10⁶ yeasts/g bagasse |
| Initial pH | 6 |

The composition of the culture medium is as follows
dry bagasse (1 kg),
slop (1.04 L),
mineral solution 1 (490 mL),
mineral solution 2 (49.2 mL),
inoculum (622 mL).

The composition of mineral solution 1 is as follows (for 1 L): 155 g of (NH₄)₂SO₄ and 46.78 g of (NH₄)₂HPO₄.

The composition of mineral solution 2 is as follows (for 100 mL): 14.88 g of MgSO₄

The bagasse is washed, dried and sieved (diameter of particles between 0.54 and 3 mm) and sterilized for 1 hour at 121° C. It is then mixed in non-sterile manner with the salts, slop and inoculum and introduced into the reactor.

The reactor is then fed with ethanol (descending flow) with a load of approximately 200 g/h·m³ for 10 days then of 150 g/h·m³ for the following 6 days. For this, the flow of air fed varied from 480 to 1200 L/h and the ethanol concentration in the air varied from 2 to 9 g/m³.

The elimination efficiency (EE) is 100% for the first 6 days and then falls to 60% on the 7^{th} day. In order to restore this EE, 1 L of mineral solution containing 59.3 g of (NH₄)₂SO₄, 17.9 g of (NH₄)₂ HPO₄ and 5.66 g of MgSO₄ was added. 1 L of sterile water was also added to the reactor per day in order to compensate for the water lost through evaporation and thus prevent the medium from drying out.

Throughout the experiment, an elimination capacity (CE) varying from 130 to 220 g/h·m³ was obtained. The maximum biomass was reached at the end of 8 days with the following levels of proteins: 13.7; 5.8 and 5.1 g per 100 g of dry bagasse, in the inlet, middle and outlet modules, respectively, i.e. an average level of 8.2 g per 100 g of dry bagasse in the reactor as a whole. The final pH is 2.6; 2.5 and 2.3 in the inlet, middle and outlet modules, respectively.

Production of the Inoculum:

The yeast strain (a rod) is introduced into an Erlenmeyer flask containing the molasses (52 g/l) and supplemented with ammonium sulphate (5.45 g/l) and ammonium phosphate (1.22 g/l). The receptacle is then placed on an incubator with orbital stirring (200 rpm) at 30° C. Rate of inoculation: 1.78×10⁶ yeasts/g bagasse).

1-23. (canceled)

24. A process for enriching lignocellulosic residue with yeast proteins comprising:
culturing distillery slop with sugar cane molasses and yeast.

25. The method according to claim 24 wherein the lignocellulosic residue is bagasse or straw,

26. The method according to claim 24, characterized in that the process for enriching bagasse with yeast proteins comprises a stage of preparation of an active inoculum by incubation of at least one strain of forage yeast with sugar cane molasses.

27. The according to claim 26 wherein the at least one strain of forage yeast is Candida utilis.

28. The method according to claim 26, characterized in that the process for enriching bagasse with yeast proteins comprises a stage of culturing the active inoculum with distillery slop on sugar cane bagasse.

29. Process for enriching lignocellulosic residue with yeast proteins, comprising the following stages:
the preparation of an active inoculum by incubation of at least one strain of forage yeast, with sugar cane molasses and
the continuous addition to the lignocellulosic residue, which has been introduced to said active inoculum with distillery slop, of ethanol, as a source of carbon, permitting the consumption of the ethanol by the aforementioned yeast and the production of lignocellulosic residue enriched with yeast proteins.

30. Process for enriching lignocellulosic residue with yeast proteins, comprising the following stages:
the preparation of an active inoculum by incubation of at least one strain of forage yeast, with sugar cane molasses,
the culturing of the said active inoculum with distillery slop on the lignocellulosic residue and
the continuous addition to the lignocellulosic residue of ethanol as a source of carbon, permitting the consumption of the ethanol by the aforementioned yeast and the production of lignocellulosic residue enriched with yeast proteins.

31. Process for enriching bagasse with yeast proteins according to claim 29, comprising the following stages:
the preparation of an active inoculum by incubation of at least one strain of forage yeast with sugar cane molasses,
the mixing of the active inoculum as obtained in the previous stage with distillery slop,
the introduction of the mixture as obtained in the previous stage on sugar cane bagasse and
the continuous addition to the sugar cane bagasse of ethanol as a source of carbon, permitting the consumption of the ethanol by the aforementioned yeast and the production of bagasse enriched with yeast proteins.

32. Process for enriching bagasse with yeast proteins according to claim 29, comprising the following stages:
the preparation of an active inoculum by incubation of at least one strain of forage yeast with sugar cane molasses,
the filling of a reactor with sugar cane bagasse, with the active inoculum as obtained in the previous stage and with distillery slop and
the continuous feeding of the said reactor filled according to the previous stage with ethanol vapours, permitting the consumption of the said ethanol vapours by the aforementioned yeast and the production of bagasse enriched with yeast proteins.

33. Process for enriching bagasse with yeast proteins according to claim 32, comprising the following stages:
the preparation of an active inoculum by incubation of at least one strain of forage yeast with sugar cane molasses,
the filling of a reactor with sugar cane bagasse and active inoculum as obtained in the previous stage, cultured with distillery slop, and
the continuous feeding of said reactor filled according to the previous stage with ethanol vapours, permitting the consumption of the said ethanol vapours by the aforementioned yeast and the production of bagasse enriched with yeast proteins.

34. Process for enriching bagasse with yeast proteins according to claim 32, comprising the following stages:
the preparation of an active inoculum by incubation of at least one strain of forage yeast with sugar cane molasses,
the mixing of the active inoculum as obtained in the previous stage with distillery slop,
the filling of a reactor with the mixture as obtained in the previous stage and sugar cane bagasse, and
the continuous feeding of the said reactor filled according to the previous stage with ethanol vapours, permitting the consumption of the said ethanol vapours by the aforementioned yeast and the production of bagasse enriched with yeast proteins.

35. Process according to claim 31, characterized in that the sugar cane bagasse is ground fresh bagasse, the particles of which have a diameter of approximately 0.1 to approximately 5 mm.

36. Process according to claim 35 wherein the diameter is approximately 0.54 mm to approximately 3 mm.

37. Process according to claim 31, characterized in that the sugar cane molasses used in the stage of preparation of the inoculum is supplemented with nitrogen.

38. Process according to claim 37, characterized in that the sugar cane molasses used in the stage of preparation of the inoculum is supplemented with ammonium sulphate and with ammonium phosphate.

39. Process according to claim 37, characterized in that the strain of yeast is incubated in the presence of approximately 22 to approximately 82 g·L⁻¹ of molasses, of approximately 3 to approximately 8 g·L⁻¹ of ammonium sulphate and of approximately 0.5 to approximately 2 g·L⁻¹ of ammonium phosphate.

40. Process according to claim 39 characterized in that the strain of yeast is incubated in the presence of approximately 22 to approximately 52 g·L⁻¹ of molasses, of approximately 3 to approximately to approximately 5.5 g·L⁻¹, of ammonium sulphate and of approximately 0.5 to approximately 1.2 g·L⁻¹, of ammonium phosphate.

41. Process according to claim 31, characterized in that the stage of incubation of the strain of yeast with the sugar cane molasses is carried out at a temperature of approximately 25 to approximately 35° C. for a period varying from approximately 15 hours to approximately 22 hours.

42. Process according to claim 31, characterized in that the distillery slop is enriched beforehand with nitrogen salts, phosphorus salts and magnesium salts, the said slop preferably being enriched beforehand with ammonium sulphate at the rate of approximately 73 g·L⁻¹, with ammonium phosphate at the rate of approximately 22 g·L⁻¹ and with magnesium sulphate at the rate of approximately 7 g·L⁻¹.

43. Process according claim 31, characterized in that the strain of yeast has water added, in order to obtain a water content of approximately 60 to approximately 75% relative to the total weight of the wet bagasse.

44. Process according to claim 31, characterized in that the reactor is fed with the ethanol at the rate of approximately 100 g·h⁻¹·m⁻³ of reactor to approximately 200 g·h⁻¹·m⁻³ of reactor.

45. Process according to claim 43, characterized in that the reactor is fed with the ethanol at the rate of approximately 150 to approximately 200 g·h⁻¹·m⁻³ of reactor.

46. Process according to claim 31, characterized in that the stage of feeding the reactor with ethanol is carried out continuously in particular for approximately 7 days at ambient temperature.

47. Process according to claim 31, characterized in that the reactor can be fed with ethanol in descending flow and/or or in ascending flow.

48. Process according claim 31, characterized in that the upper part of the reactor is sprayed with a solution of slop supplemented with nitrogen and with phosphorus.

49. Process according to claim 31, characterized in that water is added at points during the process.

50. Process according to claim 48, characterized in that water is added at points during the process in a quantity comprised of 50 mL to 200 mL per litre of reactor per day.

51. Process according to claim 29, characterized in that it comprises a supplementary final stage consisting of drying with dry air the final product corresponding to the bagasse enriched with yeast proteins and collecting the thus-dried product.

52. Process according to claim 29, characterized in that the bagasse enriched with yeast proteins has a protein content of approximately 5 to approximately 17.

53. Process according to claim 29, characterized in that the bagasse enriched with yeast proteins has a protein content of approximately 17% relative to the total weight of dry bagasse.

54. Product as obtained according to the process as defined in claim 29.
